(19) United States
(12) Patent Application Publication
(10) Pub. No.: US 2022/0027819 A1
(43) Pub. Date: Jan. 27, 2022

(54) SYSTEMS AND METHODS FOR ORTHOGONAL INDIVIDUAL PROPERTY DETERMINATION

(71) Applicant: Fidelity Information Services, LLC, Jacksonville, FL (US)

(72) Inventor: John THUMA, Lutz, FL (US)

(73) Assignee: Fidelity Information Services, LLC.

(21) Appl. No.: 16/947,200

(22) Filed: Jul. 22, 2020

(51) Int. Cl. G06Q 10/06; G06Q 30/00; G06N 20/00; G06Q 30/02

(52) U.S. Cl. CPC G06Q 10/06315; G06Q 30/0201; G06N 20/00; G06Q 30/016

(57) ABSTRACT

Systems, methods, and apparatuses for determining a next action for an individual include receiving, from a user device, a request for an interaction associated with an individual; retrieving, from a database, a data set associated with the individual; generating an orthogonal time series object based on the data set, wherein the orthogonal time series object comprises a geometric representation of a set of attributes associated with the individual; based on the orthogonal time series object, identifying an action; and transmitting the identified action to the user device.

### TECHNICAL FIELD

This disclosure concerns data science techniques. In particular, this disclosure concerns methods and systems of quantifying individual next best action based on a data set by using orthogonal valuation.

### BACKGROUND

Companies or enterprises compete with each other to attract, grow, and manage existing accounts. Traditional models and business practices attempt to manage clients into large groups called account segments. Enterprises, for example, financial institutions, often use clustering techniques based on account balance summaries, demographics, and other customer features to group clients into segments. Each segment can have thousands to millions of account members, and thus, determining individual next best actions for each client is impractical. Or, next best actions can be determined for the segment based on data common to the segment, but not for each client based on information particular to one client. The identification and consideration of customers by segments can result in unhappy and mismanaged clients, as well as a waste of resources and capital.

For example, with generalized data and analysis for each segment, it is difficult to predict which client accounts to retain, how to communicate with different clients, when to make an offer to a client, what offer may have the best value for a client, and whether to invest resources in a client. Further, with large data sets associated with segments, enterprises cannot accurately or efficiently measure a client's value to the enterprise. Thus, enterprises are unable to optimize product management, marketing campaigns, and account acquisition and growth.

### SUMMARY

Consistent with the present embodiments, a system for determining a next action associated with an identity is disclosed, the system comprising at least one processor and at least one non-transitory memory storing instructions to perform operations when executed by the at least one processor. The operations include receiving, from a user device, a request for an interaction associated with an individual; retrieving, from a database, a data set associated with the individual; generating an orthogonal time series object based on the data set, wherein the orthogonal time series object comprises a geometric representation of a set of attributes associated with the individual; based on the orthogonal time series object, identifying an action; and transmitting the identified action to the user device.

Consistent with the present embodiments, a method for determining a next action associated with an individual is disclosed. The method includes receiving, from a user device, a request for an interaction associated with an individual; retrieving, from a database, a data set associated with the individual; generating an orthogonal time series object based on the data set, wherein the orthogonal time series object comprises a geometric representation of a set of attributes associated with the individual; based on the orthogonal time series object, identifying an action; and transmitting the identified action to the user device.

Consistent with other disclosed embodiments, a non-transitory computer readable storage medium may store program instructions, which are executed by at least one processor device and perform operations. The operations include receiving, from a user device, a request for an interaction associated with an individual; retrieving, from a database, a data set associated with the individual; generating an orthogonal time series object based on the data set, wherein the orthogonal time series object comprises a geometric representation of a set of attributes associated with the individual; based on the orthogonal time series object, identifying an action; and transmitting the identified action to the user device.

The foregoing general description and the following detailed description are example and explanatory only and are not restrictive of the claims.

### BRIEF DESCRIPTION OF THE DRAWINGS

The drawings are not necessarily to scale or exhaustive. Instead, emphasis is generally placed upon illustrating the principles of the embodiments described herein. The accompanying drawings, which are incorporated in and constitute a part of this specification, illustrate several embodiments consistent with the disclosure and, together with the description, serve to explain the principles of the disclosure. In the drawings:

FIG. 1 is a schematic diagram of an exemplary system for generating orthogonal time series objects consistent with disclosed embodiments.

FIG. 2 is a schematic diagram of a system for an orthogonal time series object, consistent with disclosed embodiments.

FIG. 3 is a flowchart of an example method for generating rolled up orthogonal time series objects, consistent with disclosed embodiments.

FIG. 4 is a schematic diagram of an exemplary enterprise system consistent with disclosed embodiments.

FIG. 5 is a schematic diagram of an example memory of an enterprise system consistent with disclosed embodiments.

FIG. 6 is a flowchart of an example method for generating orthogonal time series objects consistent with disclosed embodiments.

### DETAILED DESCRIPTION

In the following detailed description, numerous specific details are set forth in order to provide a thorough understanding of the disclosed example embodiments. However, it will be understood by those skilled in the art that the principles of the example embodiments may be practiced without every specific detail disclosed herein. Well-known methods, procedures, and components have not been described in detail so as not to obscure the principles of the example embodiments. Unless explicitly stated, the example methods and processes described herein are not constrained to a particular order or sequence, or constrained to a particular system configuration. Additionally, some of the described embodiments or elements thereof may occur or be performed simultaneously, at the same point in time, or concurrently.

Financial institutions receive vast amounts of data from clients, and generate even more data. For example, financial institutions may record an interaction between a client and the institution, the client and another financial institution, the client and an individual, and the client and a company. Yet, due to processing and computing limitations, it is impractical to analyze this data for each client. Rather, traditional models and business practices attempt to manage clients by grouping them in account segments, representing thousands to millions of clients, through clustering techniques based on account balance summaries, demographics, and other customer features. However, each segment reflects information common to its account members. Thus, it is difficult to optimize next actions and offers with respect to each client. This leads to inefficiencies in product management, marketing campaigns, account acquisition and growth, and customer value measurements. These inefficiencies result in wasted time and money by financial institutions in focusing efforts on clients who may not generate a return. And, it results in the lack of a tailored solution for each client, leading to client unhappiness or mismanagement.

This disclosure provides methods and systems for determining individual next best action or offers based on a data set. For example, the system may receive a data set associated with an individual, generate an orthogonal time series object based on the data set, and identify a next action based on the data set.

Reference will now be made in detail to the disclosed embodiments, examples of which are illustrated in the accompanying drawings.

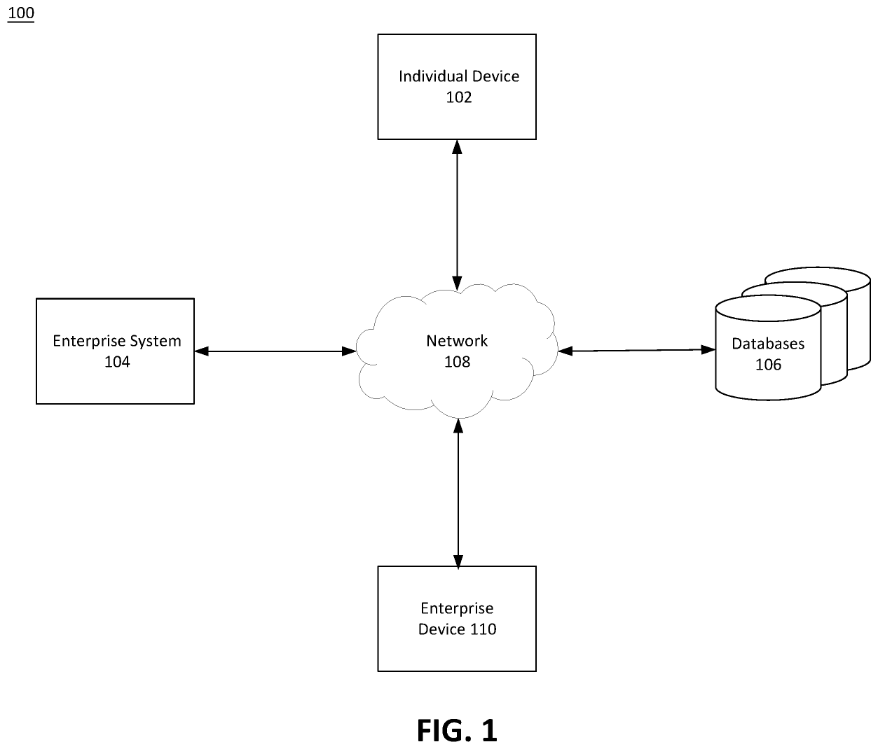

FIG. 1 is a schematic diagram of a system 100 for generating orthogonal time series objects (“OTSOs”) for individual associated with an enterprise consistent with disclosed embodiments. As depicted in FIG. 1, system 100 may include an individual device 102 associated with an individual, an enterprise device 110, an enterprise system 104, and databases 106 connected by network 108.

Individual device 102 may be any device associated with an individual, e.g., a customer of the enterprise or individual associated with the enterprise. For example, device 102 may be a computer, smart device, phone, tablet, wearable device, etc. through which the individual may interact with the enterprise. In some embodiments, device 102 may be a kiosk, automated teller machine (ATM), or other computing device associated with the enterprise.

Individual device 102 may include one or more computing devices configured to perform operations consistent with disclosed embodiments. For example, individual device 102 may include at least one of a desktop computer, a laptop, a server, a mobile device (e.g., tablet, smart phone, etc.), a gaming device, a wearable computing device, or other type of computing device. Individual device 102 may include one or more processors configured to execute software stored as instructions in memory. Individual device 102 may implement software to perform Internet-related communication and content display processes. For instance, individual device 102 may execute browser software that generates and displays interfaces, including content, on a display device included in, or connected to, individual device 102. Individual device 102 may execute applications that allow individual device 102 to communicate with components over network 108, and generate and display content in interfaces via a display device included in individual device 102. The disclosed embodiments are not limited to any particular configuration of individual device 102. For instance, individual device 102 can be a mobile device that stores and executes mobile applications that interact with databases 106 and network 108 to perform aspects of the disclosed embodiments, such as executing transactions using an account associated with the financial institution. In certain embodiments, individual device 102 may be a device associated with an enterprise, e.g., a kiosk, an ATM, an interactive device, etc., configured to be accessed and used by an individual.

Individual device 102 may be configured to receive input from the individual via an application or program running on the device. In other embodiments, device 102 may enable the individual to conduct business through a web browser running on the device. Via device 102, the individual may conduct transactions with the enterprise. For example, the individual may apply for loans (e.g., auto loans, student loans, mortgages, personal loans, or the like), manage accounts (e.g., open or close a checking account, open or close a credit card account, manage balances of accounts, etc.).

Enterprise system 104 may be a computing device capable of processing and/or receiving data, such as a personal computer (e.g., a desktop, laptop, workstation, or the like); server, a cloud computing environment or a virtual machine (e.g., virtualized computer, container instance, etc.); a special-purpose computing device, such as a specialized server or computer (e.g., a network appliance, or the like); or the like.

Enterprise system 104 may be configured to manage the various elements of system 100. In some embodiments, enterprise system 104 may be configured to receive data associated with individuals and transmit this received data to databases 106. In some embodiments, enterprise system 104 may be configured to retrieve data associated with one or more individuals from databases 106 and may analyze the retrieved data. In another embodiment, a user, via enterprise device 110, may access data stored in databases 106 via enterprise system 104.

Enterprise system 104 may be configured to record data associated with an individual's interactions with the enterprise. In some embodiments, enterprise system 104 may be part of a financial service system associated with a financial institution or may obtain the transaction data from such a financial service system. For example, enterprise systems of a financial institution may include: core banking (checking, savings, money markets, certificates of deposits), loan management, payment card (debit/credit/ACH payment), loyalty, fraud, retirement account, customer relationship management, call/contact center, marketing solutions, and mobile applications.

Databases 106 may be one or more databases associated with the enterprise. Databases 106 may receive data from enterprise system 104. For example, data may be collected during the individual's interactions with the financial institution and may be transmitted to databases 106 via network 108. Databases 106 may include one or more computing devices configured to provide data to one or more of enterprise device 110 or network 108 and to receive data from individual device 102. In some aspects, such data can include data related to an individual's interactions with and transactions with an enterprise. Data stored by databases 106 may include data related to the demographics, financial history, or other data associated with the individual.

Databases 106 may include, for example, one or more Oracle™ databases, Sybase™ databases, or other relational databases or non-relational databases, such as Hadoop™ sequence files, HBase™, or Cassandra™. Databases 106 may include computing components (e.g., database management system, database server, etc.) configured to receive and process requests for data stored in memory devices of the database(s) and to provide data from the database(s). While databases 106 are shown separately, in some embodiments databases 106 may be included in or otherwise related to one or more of enterprise system 104, enterprise device 110, and/or network 108.

Network 108 may be any type of network configured to provide communications between components of system 100. For example, network 108 may be any type of network (including infrastructure) that provides communications, exchanges information, and/or facilitates the exchange of information, such as the Internet, a Local Area Network, near field communication (NFC), optical code scanner, or other suitable connection(s) that enables the sending and receiving of information between the components of system 100. In some embodiments, one or more components of system 100 can communicate through network 108. In various embodiments, one or more components of system 100 may communicate directly through one or more dedicated communication links.

Enterprise device 110 may include one or more computing devices configured to perform operations consistent with disclosed embodiments. Enterprise device 110 may be a device associated with the enterprise. For example, enterprise device 110 may include at least one of a desktop computer, a laptop, a server, a mobile device (e.g., tablet, smart phone, etc.), a gaming device, a wearable computing device, or other type of computing device. Enterprise device 110 may include one or more processors configured to execute software stored as instructions in memory. Enterprise device 110 may implement software to perform Internet-related communication and content display processes. For instance, enterprise device 110 may execute browser software that generates and displays interfaces, including content, on a display device included in, or connected to, enterprise device 110. Enterprise device 110 may execute applications that allow enterprise device 110 to communicate with components over network 108 and generate and display content in interfaces via a display device included in enterprise device 110. The disclosed embodiments are not limited to any particular configuration of enterprise device 110. For instance, enterprise device 110 may be a mobile device that stores and executes mobile applications that interact with databases 106 and network 108 to perform aspects of the disclosed embodiments, such as analyzing data sets associated with one or more individuals.

It is to be understood that the configuration and boundaries of the functional building blocks of system 100 have been defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

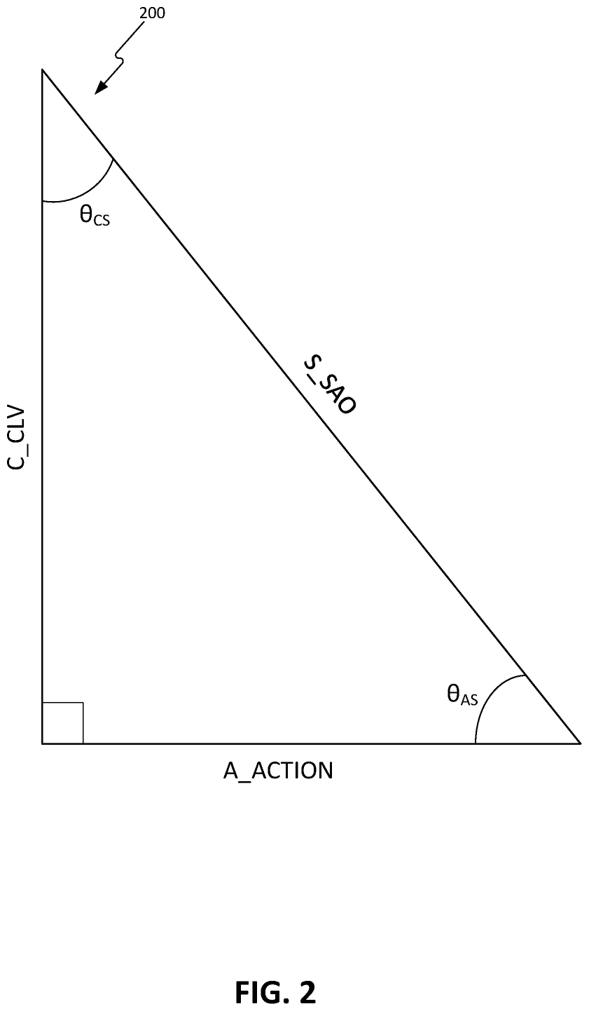

FIG. 2 illustrates a geometric representation of a system 200 for an orthogonal time series object (OTSO), consistent with disclosed embodiments. An OTSO may be represented by a right triangle having sides representing customer lifetime value (C_CLV), action opportunities (A_ACTION), and surface area opportunity (S_SAO). Each account associated with an individual may be measured based on the length of each side (e.g., C_CLV, A_ACTION, and S_SAO) and the angular values of the two non-right angles (e.g., θ_{CS} and θ_{AS}). θ_{CS} may represent the non-right angle between lengths S_SAO and C_CLV. θ_{AS} may represent the non-right angle between lengths S_SAO and A_ACTION. The values for the length of each side and the angular values may be referred to as orthogonal quantities.

Orthogonal quantities may be stored in a database or in a file storage system. Data may be stored to a disk after the process that creates the data ends. Processing may be executed in memory using a processing system such as Apache Spark. Data may be processed using a variety of programming languages. Programming languages may include Structured Query Language, R, Python, or Java. The choice of programming language may be based on specifications or capabilities, for example, application programming interfaces (APIs), relational queries, or a service oriented architecture. The programming language may be technology agnostic to allow for flexibility when processing data.

Although the example depicted in FIG. 2 is discussed below with respect to a financial institution, the systems and methods described herein are applicable to any organization or enterprise associated with one or more customers, clients, users, or individuals. An institution may determine an action related to account associated with an individual. An action may be an organic action (“O_{ACTION}”) or an inorganic action (“I_{ACTION}”). Organic actions may include potential offers made to an individual that the individual does not participate in with the institution, e.g., for a financial institution, a holder of the account uses a product of a competing financial institution. Organic actions may represent activities such as offers or activities related to products that are offered by the institution. Inorganic actions may represent offers or activities that the individual is participating in that are not offered by the institution. For example, an account holder may use a competing product that the financial institution itself does not offer. Banking product development can use information about inorganic actions to make data driven decisions about what products to create and take to market. Although actions are exemplified by organic and inorganic actions, it is contemplated that actions may be classified in a multitude of ways. For example, actions may be classified as actions native to an institution and its partners and actions not native to an institution and its partners. In addition, the types of considered actions may be narrowed to a small number of actions relevant to a particular business model. These attributes may be used to calculate customer interactions, revenue, and costs.

Referring to FIG. 2, A_ACTION is the sum total of organic and inorganic opportunities with a financial institution and an account member. A_ACTION may be represented by Equation 1:

A_Action=Σ(O_{ACTION})+Σⁿ(I_{ACTION})

where O_{ACTION} represents an organic action and I_{ACTION} represents an inorganic action. O_{ACTION} and I_{ACTION} may each include a count of the type of action. O_{ACTION} and I_{ACTION} may each include a currency amount. The currency amount may be based on at least one of the type of action or the value of the action.

C_CLV may represent a customer lifetime value. Customer lifetime value may include a net value of an individual to the financial institution based on activities and events that generate positive value less activities and events that generate negative value. Customer lifetime value may include a projected value or a current value. Customer lifetime value may include an estimate of the value of the customer based on the customer's interactions with the institution. Customer lifetime value may include the value of the customer's interactions with the institution. The net value of the individual may include a currency amount. The activities and events that generate positive value may include opening a new account, adding funds, maintaining an average balance, making payments for services, transactions, or generating loyalty points through programs, offers, or meeting requirements for participation. The activities and events that generate negative value may include having insufficient funds, falling below an average balance, failing to make payments for services, lack of transactions, calls to contact centers, branch visits, mobile application use, web site use, closing an account, or overdrawing an account. C_CLV may be represented by Equation 2:

C_CLV=Σ(R_{ACTION})−Σ(C_{ACTION})

where R_{ACTION} represents a revenue-generating action and C_{ACTION} represents a cost-generating action.

S_SAO may represent surface area opportunity. Surface area opportunity may assign a value to an individual's potential value to the financial institution. An individual S_SAO (“Individual(S_SAO)”) may calculated by Equation 3:

Individual(S_SAO)²=(A_ACTION²+C_CLV²)

After calculating an individual S_SAO, the enterprise S_SAO (“Enterprise(S_SAO)”) may be represented by Equation 4 as:

Enterprise(S_SAO)=Σ(Individual(S_SAO)²)

The enterprise surface area opportunity may be used to benchmark whether the financial institution is capturing a significant portion of its customers' potential value. The enterprise surface area opportunity may be a rolled up value that reflects a time period (e.g., daily, weekly monthly). The enterprise surface area opportunity from one time period may be compared to the enterprise surface area opportunity from a different time period of the same length. The enterprise surface area opportunity may represent a value of missed opportunity of the financial institution. The enterprise surface area opportunity may be used to increase or decrease resource use. The enterprise surface area opportunity of a geographic region may be compared to the enterprise surface area opportunity from another geographic region. The enterprise surface area opportunity of a demographic may be compared to the enterprise surface area opportunity from another demographic.

The action taken by the enterprise system may be associated with an institution program. The enterprise surface area opportunity or CLV may be used to increase or decrease institution programs. Institution programs may include marketing programs such as ad campaigns and offers. Institution programs may include infrastructure programs such as improving technical support, increased branch personnel or call center support, or surveys. Institution programs may include customer support programs such as notifications, reminders, offers, or communications including personnel or bots using calls, emails, or other communication systems. Institution programs may include discontinuing service. For example, the institution may provide a customer support program for a customer that has a low CLV. As another example, the institution may provide a marketing program for a customer that has a high CLV.

The value of θ_{AS} may be measured using Equation 5:

$${θ}_{A S} = {sin}^{- 1} \frac{C\_CLV}{S\_SAO}$$

The value of θ_{CS} may be measured using Equation 6:

θ_{CS}=180−(θ_{AS}+90)

θ_{AS} and θ_{CS} may be used to measure client mobility of either value or potential actions. θ_{AS} and θ_{CS} may be measured over time to determine the effect on lengths A_ACTION, C_CLV, and S_SAO. The ratio of θ_{AS} to θ_{CS} may represent the opportunity to gain business with an account member.

Finally, the attributes discussed above may be used to determine a party value ratio (pVr). pVr may represent a collection of individual banking behaviors over time and whether the behaviors generate expense or value over time for the financial institution. pVr may be represented by Equation 7 as:

$$pVr = \frac{( Σ {R}_{ACTION} - Σ {C}_{ACTION} )}{Σ {C}_{ACTION}}$$

R_ACTION may be a value associated with the revenue generated from an action. C_ACTION may be a value associated with the cost generated from an action. pVr may be normalized to a desired value range using, for example, multiplication or addition.

An institution may use a threshold pVr to determine a next action. The threshold pVr may be specific to an institution or a type of institution. Threshold pVr values may calculated using a variety of methods.

For example, a pVr (Campaign Avoidance/Churn Accept) less than −0.2 may represent that the value of the individual to the institution is negative. A negative value may reflect that an investment is needed to repair a relationship of the individual and the institution or that the relationship is not repairable and may be discontinued. The negative value may reflect that the customer costs the financial institution more than the customer is worth over the time the customer holds an account with the financial institution. This may occur, for example, where the customer has, but no longer uses, a credit card with the financial institution, and the customer may use a competing credit card product of another financial institution.

As another example, a pVr (Campaign Repair/Churn Repair) that is greater than −0.25 and less than 0.25 reflects the value of the individual to the institution is neutral. The relationship of the individual to the institution may be repairable or improvable through offers. For example, the individual may use a product of another financial institution and a product offered by the financial institution. Thus, the financial institution may determine to invest marketing resources associated with an offer to the customer to use the product of the financial institution rather than the competing product of another financial institution.

As another example, a pVr greater than 0.25 reflects the value of the individual to the institution is positive. An individual with a higher pVr may provide more value to the institution. For example, the individual may consistently use one product of a financial institution. The individual may be more likely to use another product of the financial institution if the financial institution extends an appropriate offer. As another example, the individual may require a loan and the financial institution may invest resources to offer the loan. The financial institution may offer a lower interest rate on the loan or other terms favorable to the individual to improve the relationship between the customer and the financial institution.

The below table provides examples of a pVr value, a R_ACTION, and a C_ACTION, where each row represents calculations for a member account:

| Account No. | pVr | R_ACTION | C_ACTION |
|---|---|---|---|
| 1 | 0 | 5 | 5 |
| 2 | −0.2 | 4 | 5 |
| 3 | −0.4 | 3 | 5 |
| 4 | −0.6 | 2 | 5 |
| 5 | −0.8 | 1 | 5 |
| 6 | 0.25 | 5 | 4 |
| 7 | 0 | 4 | 4 |
| 8 | −0.25 | 3 | 4 |
| 9 | −0.5 | 2 | 4 |
| 10 | −0.75 | 1 | 4 |
| 11 | 4 | 5 | 1 |
| 12 | 1.5 | 5 | 2 |
| 13 | 0.67 | 5 | 3 |
| 14 | 0.25 | 5 | 4 |
| 15 | 0 | 5 | 5 |
| 16 | 87 | 88 | 1 |
| 17 | −0.99 | 1 | 88 |
| 18 | −0.99 | 1 | 999999 |

As illustrated in the table above, pVr may provide an easy reference to distinguish whether an account has value to the institution. For example, Account No. 11 may have a higher value to the financial institution because pVr is 4, and such a value may warrant investment to improve the relationship between the account member and the institution. As another example, Account No. 14 may have a value closer to neutral because pVr is 0.25, and such a value may warrant investment to repair the relationship between the account member and the institution. As another example, Account No. 5. may have a lower value because pVr is −0.8, and such a value may not warrant investment from the institution.

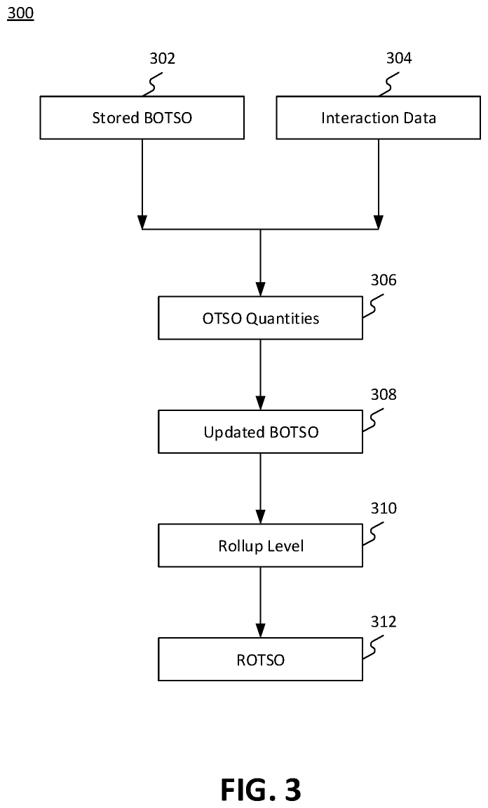

FIG. 3 shows an example data object tree 300 consistent with embodiments of this disclosure. Data object tree 300 may be performed using one or more computing devices described herein (e.g., system 100 and/or enterprise system 104, etc.). For example, one or more processors may execute instructions or codes on data stored in one or more memories to implement data object tree 300. While the same computing devices are described as performing each step of data object tree 300 for simplicity of description, different computing devices or groups of computing devices may be used to perform different steps (or different functions within each step).

Consistent with disclosed embodiments, data object tree 300 may include data objects 302-312. In some aspects, the data objects of data object tree 300 may be combined, omitted, reordered, and/or integrated into other processes to perform the tasks contemplated herein.

FIG. 3 illustrates a flowchart of determining a rolled up orthogonal time series object (ROTSO), consistent with disclosed embodiments. ROTSO 312 may be determined from one or more elements including an existing or stored base object orthogonal time series object (“BOTSO”) 302, interaction data 304, OTSO quantities 306, updated BOTSO 308, and rollup level 310. Data objects 302-312 may be determined for an individual, an entity, or an account.

Stored BOTSO 302 may include data associated with a collection of banking events. BOTSO 302 may include one or more attributes such as: an account identifier; an action type; an action description; an action accounting flag (e.g., whether the action is associated with revenue or cost); an action amount; an action start; and an action end. For example, BOTSO 302 may include data associated with a collection of actions associated with an individual account.

Interaction data 304 may include data such as a source identifier, a source description, or a value associated with an interaction. The source identifier may reflect whether the data is received from a financial institution, a government entity, an individual, or a company.

In some embodiments, stored BOTSO 302 may be updated to include data from interaction data 304. Stored BOTSO 302 may be updated from interaction data 304 to include attributes that reflect an interaction, such as an action type, an action description, an action accounting flag, an action amount, and action start, or an action end. For example, a processor may update BOTSO 302 with data associated with interaction data 304.

OTSO quantities may be calculated consistent with the disclosed embodiments and stored as data object 306. OTSO quantities 306 may be calculated using data from BOTSO 302. OTSO quantities 306 may be calculated using data from interaction data 304. OTSO quantities 306 may be calculated using data stored in memory or input by user. For example OTSO quantities 306 may include data calculated using data from a database or an input device regarding the cost of actions (C_ACTION) or the revenue of actions (R_ACTION). Calculations for OTSO quantities may be used to create OTSO quantities 306 and may include the calculations described, for example, with regards to FIG. 2. OTSO quantities 306 may include data resulting from calculations for A_ACTION, C_CLV, and S_SAO, found from using Equations 1-3 above. OTSO quantities 306 may include data resulting from calculations for B_{AS} and θ_{CS} found from using Equations 5 and 6 above. OTSO quantities 306 may include data resulting from calculates for pVr found from using Equation 7 above.

Updated BOTSO 308 may include data from stored BOTSO 302 and OTSO quantities 306. Updated BOTSO 308 may include data from interaction data 304. Updated BOTSO 308 may include data generated iteratively as new interaction data is received. Values within updated BOTSO 308 may be compared to stored BOTSO 302 to determine a change in any values or a change in values over time.

Rollup level 310 may include data received from an input device or from memory. Rollup level 310 may include a period of time used to include data of a BOTSO for a time period. Rollup level 310 may include attributes such as a rollup level identifier, a rollup level time value (e.g., weekly, monthly, yearly), or a rollup level description.

ROTSO 312 may include attributes based on rollup level 310 and data from updated BOTSO 308. ROTSO may include attributes based on rollup level 310 and data from stored BOTSO 302. In some embodiments, ROTSO 312 may include data from interaction data step 302. In some embodiments, ROTSO 312 may include data from OTSO quantities 310.

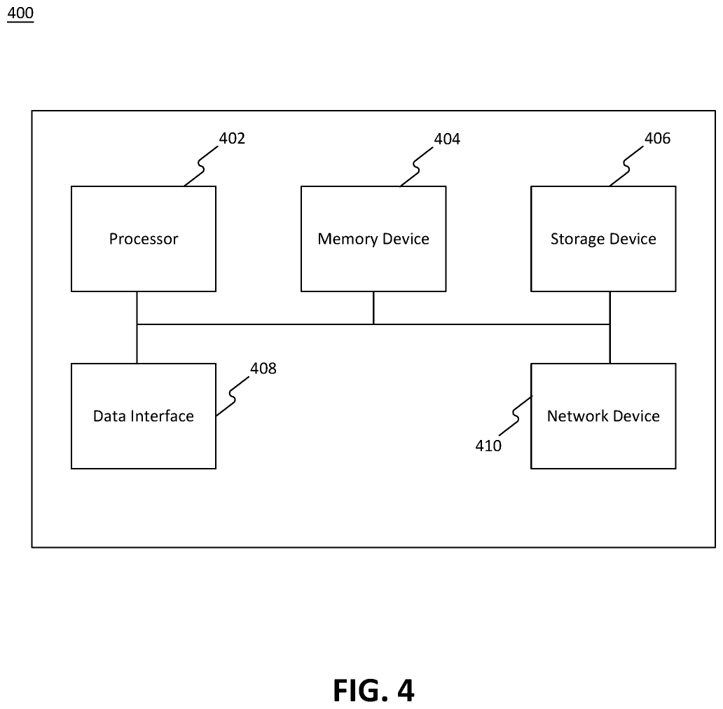

FIG. 4 is a schematic diagram of an example enterprise system 400 for identifying next best actions for individuals associated with an enterprise. Enterprise system 400 may be the same as, or similar to enterprise system 104. As shown, system 400 may include a processor 502, memory 404, storage device 406, data interface 408, and network device 410.

Processor 402 may be one or more known processing devices, such as a microprocessor from the Pentium™ or Atom™ families manufactured by Intel™, the Turion™ family manufactured by AMD™, the Exynos™ family manufactured by Samsung™, or the Snapdragon™ family manufactured by Qualcomm™. Processor 402 may constitute a single core or multiple core processors that execute parallel processes simultaneously. For example, processor 402 may be a single core processor configured with virtual processing technologies. In certain embodiments, processor 402 may use logical processors to simultaneously execute and control multiple processes. Processor 402 may implement virtual machine technologies, or other known technologies to provide the ability to execute, control, run, manipulate, store, etc., multiple software processes, applications, programs, etc. In another embodiment, processor 402 may include a multiple-core processor arrangement (e.g., dual, quad core, etc.) configured to provide parallel processing functionalities to allow system 400 to execute multiple processes simultaneously. One of ordinary skill in the art would understand that other types of processor arrangements could be employed that provide for the capabilities disclosed herein.

Memory 404 may be a volatile or non-volatile, magnetic, semiconductor, tape, optical, removable, non-removable, or other type of storage device or tangible (i.e., non-transitory) computer-readable medium that stores one or more program applications and data. Data may include, for example, data associated with individuals and/or analyzed data of one or more individuals.

Program applications may include operating systems that perform known operating system functions when executed by one or more processors. By way of example, the operating systems may include Microsoft Windows™, Unix™, Linux™, Apple™, or Android™ operating systems, Personal Digital Assistant (PDA) type operating systems, such as Microsoft CE™, or other types of operating systems. Accordingly, disclosed embodiments may operate and function with computer systems running any type of operating system. System 400 may also include communication software that, when executed by processor 402, provides communications with network 108, such as Web browser software, tablet, or smart hand held device networking software, etc.

Program applications stored in memory 404 may include an application configured to receive data associated with an individual and analyze the data to generate a BOTSO for that individual. For example, an application may be configured to retrieve data from databases 106 and analyze the retrieved data to generate BOTSOs or ROTSOs associated with one or more individuals. In some embodiments, data may be received via one or more application programming interfaces (APIs). The application may be further configured to analyze the generated BOTSOs and/or ROTSOs to determine a next best action associated with an individual. As an example, a BOTSO associated with an individual may be used to determine a pVr for that individual, based on the pVr being within a predetermined threshold, the application may generate a recommended next action for the individual. The generated next action may include, for example, an offer to extend to the individual offering an incentive to purchase a product offered by the enterprise. An incentive may include a discount, a reduced interest rate, reduced account minimum, waived service fees, or other offers configured to make the product more appealing to the individual.

Program applications stored in memory 404 may further include applications configured to generate display information associated with the analyzed information. For example, an application may determine one or more value associated with system 200, shown in FIG. 2. A program application may be configured to generate a display including a graphical representation of the generated values for one or more individuals over a predetermined or custom time period. For example, a display may include a graphical representation of an individual customer's lifetime value over a week, month, quarter, year, etc. The display information may be transmitted to enterprise device 410 and may cause enterprise device 410 to display a graphical user interface (GUI) including the graphical representation to a user via an interface of the enterprise device 410. In some embodiments, the graphical representation may be interactive, such that a user may manipulate or further analyze the displayed data.

Storage device 406 may include one or more devices configured to store data consistent with the invention. Storage device 406 may include a hard disk or flash memory storing data associated the enterprise or with one or more individuals.

System 400 may also include a data interface 408 communicatively connecting processor 402 to individual device 102, enterprise device 110, and/or databases 106. For example, data interface 408 may include any wired and/or wireless link or links for transmitting data acquired by or generated by individual device 102 or enterprise device 110 to processor 402. Data interface 408 may also be configured to receive data associated with one or more individuals via an API.

Network device 410 may include devices configured to communicate data to other components of system 100. Such as a router, a modem, an Ethernet adapter, or a wireless network adapter (e.g., IEEE 802.11).

Each component in FIG. 4 may connect to each other directly or via buses. A computing system may comprise one or more computing devices 400 (e.g., in a cluster of devices).

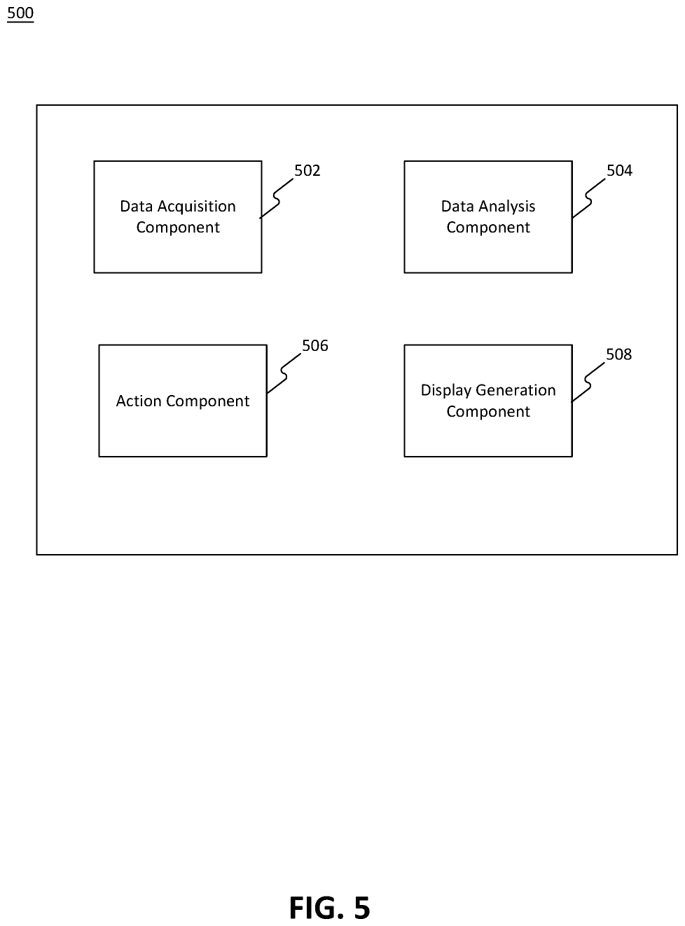

FIG. 5 illustrates an exemplary embodiment of a memory device 500 containing software components consistent with the present disclosure. As shown, memory device 500 may include a data acquisition component 502, a data analysis component 504, an action component 506, and a display component 508. Components 502-508 may contain software instructions for execution by at least one processor (e.g., processor device 402) associated with system 400. In some embodiments, data acquisition component 502, a data analysis component 504, an action component 506, and a display component 508 may cooperate to perform multiple operations.

Data acquisition component 502 may be configured to collect data associated with an individual. For example, data acquisition component 502 may receive, via data interface 408, data generated by an individual's interactions with the enterprise via individual device 102. In other embodiments, data acquisition component 502 may be configured to retrieve data from one or more databases associated with the enterprise. Data acquisition component 502 may be configured to collect information associated with an individual including demographic information, account information, transaction information, etc. Data acquisition component 502 may also receive data from external systems, e.g., systems managed by other enterprises. Such data may be received, for instance, via an API. In some embodiments, data acquisition component 502 may transmit received data for storage by databases 106.

In some embodiments, data acquisition component 502 may be configured to receive a request, e.g., from a user via enterprise device 110, for data associated with one or more individuals. Data acquisition component 502 may be configured to query databases 106 to retrieve data based on information in the request. For example, the request may specify one or more individuals using an identifier (e.g., full name, account number, customer identification, etc.), a date or date range, and/or one or more other parameters.

Data analysis component 504 may be configured to receive a retrieved data set from data acquisition component 502. Data analysis component 504 may analyze the received data to generate a BOTSO associated with one or more individuals. For example, with reference to FIG. 2, data analysis component may determine, for each individual, a customer lifetime value, a surface area opportunity, and an action using Equations 1-3, respectively, based on the retrieved data. Data analysis component 504 may further calculate, for an individual, the values of θ_{AS} and θ_{CS} using Equations 5 and 6, respectively, and the determined values for customer lifetime value and surface area opportunity. In some embodiments, using Equation 7, data analysis component 504 may calculate the pVr associated with an individual.

In some embodiments, data analysis component 504 may roll-up a generated BOTSO based on the time period included in the received request. For example, a BOTSO for an individual may be rolled up into a ROTSO based on the indicated time period.

In some embodiments, data analysis component 504 may be configured to automatically generate and update BOTSOs stored in databases 106. For example, data analysis component 504 may generate a BOTSO for each individual stored in databases 406. The BOTSOs may be generated periodically or by batch.

Action component 506 may be configured to receive BOTSO and/or ROTSO data from data analysis component 504 and may generate a next action for one or more individuals associated with the BOTSOs and/or ROTSOs. For example, action component 506 may apply one or more models or machine learning (ML) techniques to generate a set of one or more next actions to provide to an individual. For example, a next action may be based on the calculated value of θ_{CS}, θ_{AS}, S_SAO, C_CLV, A_ACTION, or pVr for a requested individual.

In some embodiments, action component 506 may include a machine learning framework (e.g., XGBoost, Tensorflow, or the like) that may include programs (scripts, functions, algorithms) to assist creation of, train, implement, store, receive, retrieve, and/or transmit one or more machine learning models. The machine learning framework may be configured to assist creation of, train, implement, store, receive, retrieve, and/or transmit, one or more ensemble models (e.g., models comprised of a plurality of models). In some embodiments, the ML framework may be configured to receive a BOTSO or ROTSO associated with an individual and identify one or more actions, from a set of possible actions, to recommend to the individual. The ML framework may be further configured to determine a likelihood associated with each action, a return and/or cost associated with each action, and/or a projection of the individual's BOTSO or ROTSO if the action is taken.

In some embodiments, action component 506 may identify one or more recommended actions by querying a lookup table based on one or more orthogonal values associated with an individual's BOTSO. For example, based on the lookup table and an individual's orthogonal values, action component 506 may generate a list of next actions. In some embodiments, the list may be ranked based on a likelihood of a positive outcome, e.g., of the individual accepting the offer or taking the action. The likelihood may be determined using one or more modelling or ML techniques to analyze data stored in databases 106.

Components 502-508 may be implemented in software, hardware, firmware, a mix of any of those, or the like. For example, if the components are implemented in software, the components may be stored in a server or distributed over a plurality of servers. In some embodiments, any one or more of components 502-508 and data associated with these components may be stored in database 206 and/or stored by system 204, which may include one or more processing devices. Processing devices of system 204, e.g., processor 402, may be configured to execute the instructions of components 502-508. In some embodiments, aspects of components 502-508 may include software, hardware, or firmware instructions (or a combination thereof) executable by one or more processors, alone, or in various combinations with each other. For example, components 502-508 may be configured to interact with each other and/or other components of system 204 to perform functions consistent with disclosed embodiments.

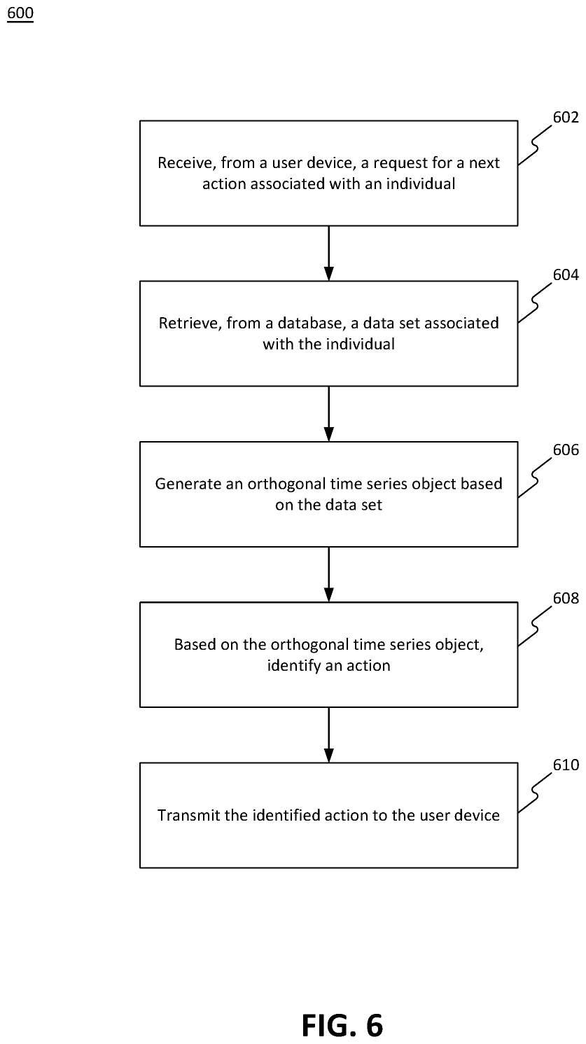

FIG. 6 shows an example method 600 consistent with embodiments of this disclosure. Method 600 may be performed using one or more computing devices described herein (e.g., system 400 and/or enterprise system 404, etc.). For example, one or more processors (e.g., processor 402) may execute instructions or codes on data stored in one or more memories (e.g. memory device 404 and/or storage device 406) to implement method 600. While the same computing devices are described as performing each step of method 600 for simplicity of description, different computing devices or groups of computing devices may be used to perform different steps (or different functions within each step).

FIG. 6 is a flowchart of an example method 600 for generating orthogonal time series objects and determining a next action associated with a user, consistent with disclosed embodiments. Consistent with disclosed embodiments, method 600 may include steps 602-610. In some aspects, the steps of method 600 may be combined, omitted, reordered, and/or integrated into other processes to perform the tasks contemplated herein.

At step 602, a processor (e.g., processor 402) may receive, from a user device, a request for a next action associated with an individual. The user device may be, for example, enterprise device 110. The request may include identifying information associated with an individual, a date range or date, and/or other parameters. The request may be received by data acquisition component 502, which may use the information included in the request to generate a query of a database (e.g., database 106).

At step 604, the processor may execute the generated query to retrieve a data set associated with the individual from the database (e.g., database 106). The retrieved data may include one or more attributes associated with the individual, such as a business account identifier; an action type; an action description; an action accounting flag (e.g., whether the action is associated with revenue or cost); an action amount; an action start; and an action end.

At step 606, the processor may generate an orthogonal time series object based on the retrieved data set. The orthogonal time series object may be a stored BOTSO (e.g. BOTSO 302), a ROTSO (e.g., ROTSO 312), an updated BOTSO (e.g. BOTSO 302 and Interaction Data 304), or Alternatively, the data analysis component 504 may retrieve a Stored BOTSO, such as BOTSO 302. For example, data analysis component 504 may receive the retrieved data, e.g. from Stored BOTSO 302, Interaction Data 304, Rollup Level 306, and generate a ROTSO for the individual using Equations 1-5. In other embodiments, the BOTSO may be directly retrieved from database 106, which stores BOTSOs associated with individuals. In some embodiments, the BOTSO may be a geometric representation of a set of attributes associated with the individual, e.g., a geometric representation of the values determined using Equations 1-3 and 5-7.

At step 608, based on the BOTSO, the processor may identify an action. As previously described, action component 506 may apply one or more models to a BOTSO associated with an individual to identify one or more actions configured to increase engagement of the individual or revenue from the individual. In other embodiments, action component 506 may apply a machine learning framework configured to identify actions based on an individual's BOTSO. In another embodiment, a lookup table may be used to identify one or more recommended actions.

At step 610, the processor may transmit the identified action to the user device, e.g., enterprise device 110. The identified action may be transmitted to enterprise device 110 via network 108. In some embodiments, the transmitted action may have the highest predicted likelihood among the actions identified at step 608. In some embodiments, display generation component 508 may generate a graphical user interface including a graphical representation of the generated OTSO and/or a textual or graphical indication of the identified action.

In some embodiments, the user interface may indicate relative predicted outcomes of one or more actions based on the individual's BOTSO. The user interface may be printed, displayed on a screen, communicated via a network, stored in a database, stored in a computer (e.g., a local computer or a cloud server), or the like. In some embodiments, the report data may be presented (e.g., displayed on a screen, printed on papers, sent via emails, popped up as a smartphone push notification, or the like) to a user or an entity related to the enterprise.

In some embodiments, an enterprise system (e.g. enterprise system 404) may take the recommended action with respect to the individual. For example, the action may be to offer a product to the individual or offer an incentive to the individual. As another example, the action may be to not extend an offer to the individual. By improving the granularity with which individuals are targeted for actions, an institution and the individual may, for example, reach improved outcomes, including a tailored solution for the individual and an increased revenue for the institution. As another example, the recommended action may indicate the enterprise should take no action with respect to the individual if the likely revenue from that individual does not outweigh the cost of other available actions.

In some embodiments, an enterprise system (e.g. enterprise system 404) may be updated when an action is identified according to an enterprise surface area opportunity, a CLV, or a BOTSO or ROTSO. The identified action may be a recommended action. The enterprise system may be updated when an enterprise surface area opportunity or CLV surpasses or falls below a threshold and a corresponding recommended action is identified. The enterprise system may be updated when a BOTSO or ROTSO is calculated and a corresponding action is identified. The enterprise system may prepare a notification based on the identified action and send the notification to an enterprise device (e.g. enterprise device 110). The enterprise device may be configured to accept the identified action. The enterprise system may be configured to use an element of a system (e.g. system 100) to take a recommended action.

In some embodiments, the recommended action may be a communication sent through a network (e.g. network 108) to a device associated with an individual (e.g. individual device 102). The communication may provide the individual an offer, a questionnaire, a reminder, a notification, or a response option. The response option may include a call (e.g., an automated message from an automated question and answer service), a mobile device application selection, a web site selection, a text or message (e.g., an automated message from an automated question and answer service), or other communication. The response option may be associated with an institution program, the response option including, for example, a call to a call center for support, acceptance of an offer, closing an account, moving money from one account to another, making a payment, making an appointment for a branch visit, or another action associated with the institution program.

Systems and methods disclosed herein involve unconventional improvements over prior methods of analyzing customer data. Descriptions of the disclosed embodiments are not exhaustive and are not limited to the precise forms or embodiments disclosed. Modifications and adaptations of the embodiments will be apparent from consideration of the specification and practice of the disclosed embodiments. Additionally, the disclosed embodiments are not limited to the examples discussed herein.

The foregoing description has been presented for purposes of illustration. It is not exhaustive and is not limited to the precise forms or embodiments disclosed. Modifications and adaptations of the embodiments will be apparent from consideration of the specification and practice of the disclosed embodiments. For example, the described implementations include software, but methods consistent with the present disclosure may be implemented as hardware alone.

Computer programs based on the written description and methods of this specification are within the skill of a software developer. The various functions, scripts, programs, or modules may be created using a variety of programming techniques. For example, programs, scripts, functions, program sections or program modules may be designed in or by means of languages, including JavaScript, C, C++, Java, PHP, Python, Ruby, Perl, or other programming or scripting languages. One or more of such software sections or modules may be integrated into a computer system, non-transitory computer-readable media, or existing communications software. The programs, modules, or code may also be implemented or replicated as firmware or circuit logic.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as non-exclusive. Further, the steps of the disclosed methods may be modified in any manner, including by reordering steps or inserting or deleting steps. It is intended, therefore, that the specification and examples be considered as example only, with a true scope and spirit being indicated by the following claims and their full scope of equivalents.

1. A system for determining a next action for an individual, the system comprising:
at least one processor; and
at least one non-transitory memory storing instructions to perform operations when executed by the at least one processor including:
receiving, from a user device, a request for a financial interaction associated with an individual;
retrieving, from a database, a data set associated with the individual;
aggregating the financial interaction with the data set;
generating an orthogonal time series object based on the aggregated data set, wherein the orthogonal time series object comprises a geometric representation of a set of attributes associated with the individual;
comparing the orthogonal time series object to a stored orthogonal time series object and determining a difference;
based on the difference and the request, identifying an action by querying a table; and
transmitting the identified action to the user device.

2. The system of claim 1, wherein the orthogonal time series object comprises a customer lifetime value, a surface area opportunity, and an action sum.

3. The system of claim 2, wherein the customer lifetime value comprises a net value to an entity based on events that generate a positive value less events that generate a negative value.

4. The system of claim 2, wherein surface area opportunity comprises a potential value associated with the individual.

5. The system of claim 2, wherein the action sum comprises a sum of one or more opportunities available to the individual.

6. The system of claim 1, wherein the request comprises a time period.

7. The system of claim 6, wherein the operations further comprise:
generating a rolled-up orthogonal time series object for the individual based on the orthogonal time series object and the time period.

8. The system of claim 1, wherein identifying the action comprises applying a machine learning model to the orthogonal time series object.

9. The system of claim 1, wherein the operations further comprise:
generating a graphical user interface configured to display a graphical representation of the orthogonal time series object and the identified action.

10. The system of claim 9, wherein transmitting the identified action to the user device comprises transmitting instructions configured to cause the user device to display the graphical user interface via a display of the user device.

11. A computer-implemented method for determining a next action for an individual, the method comprising:
receiving, from a user device, a financial interaction associated with an individual;
retrieving, from a database, a data set associated with the individual;
aggregating the financial interaction with the data set;
generating an orthogonal time series object based on the aggregated data set, wherein the orthogonal time series object comprises a geometric representation of a set of attributes associated with the individual;
comparing the orthogonal time series object to a stored orthogonal time series object and determining a difference;
based on the difference and the request, identifying an action by querying a table.

12. The method of claim 11, wherein the orthogonal time series object comprises a customer lifetime value, a surface area opportunity, and an action sum.

13. The method of claim 12, wherein the customer lifetime value comprises a net value to an entity based on events that generate a positive value less events that generate a negative value.

14. The method of claim 12, wherein surface area opportunity comprises a potential value associated with the individual.

15. The method of claim 12, wherein the action sum comprises a sum of one or more opportunities available to the individual.

16. The method of claim 11, wherein the request comprises a time period.

17. The method of claim 16, wherein the method further comprises:
generating a rolled-up orthogonal time series object for the individual based on the orthogonal time series object and the time period.

18. The method of claim 11, wherein identifying the action comprises applying a machine learning model to the orthogonal time series object.

19. The method of claim 11, wherein the operations further comprise:
generating a graphical user interface configured to display a graphical representation of the orthogonal time series object and the identified action.

20. A non-transitory computer-readable storage medium comprising instructions for determining a next action for an individual, wherein instructions when executed by a processor perform operations comprising:
receiving, from a user device, a financial interaction associated with an individual;
retrieving, from a database, a data set associated with the individual;
aggregating the financial interaction with the data set;
generating an orthogonal time series object based on the aggregated data set, wherein the orthogonal time series object comprises a geometric representation of a set of attributes associated with the individual;
comparing the orthogonal time series object to a stored orthogonal time series object and determining a difference;
based on the difference and the request, identifying an action by querying a table.
